(19) United States
(12) Patent Application Publication
(10) Pub. No.: US 2018/0367492 A1
(43) Pub. Date: Dec. 20, 2018

(54) PROVIDING NOTIFICATION BASED ON DYNAMIC GROUP

(71) Applicant: MICROSOFT TECHNOLOGY LICENSING, LLC, Redmond, WA (US)

(72) Inventor: Michael J. KUMAR, Seattle, WA (US)

(73) Assignee: MICROSOFT TECHNOLOGY LICENSING, LLC, Redmond, WA (US)

(21) Appl. No.: 15/626,280

(22) Filed: Jun. 19, 2017

(51) Int. Cl. H04L 12/58

(52) U.S. Cl. CPC H04L 51/24; H04L 51/14; H04L 51/36

(57) ABSTRACT

Variety of approaches to provide a notification based on a dynamic group are described. A communication service initiates operation(s) to provide a notification based on a dynamic group upon receiving a communication from a sender that is transmitted to a recipient. Next, the sender is detected as a member of a dynamic group. Furthermore, a notification is determined as associated with the dynamic group and a communication type. A client application associated with the recipient is prompted to render the notification in conjunction with an arrival of the communication.

### BACKGROUND

Information exchange have changed processes associated work and personal environments. Automation and improvements in processes have expanded scope of capabilities offered for personal and business data consumption. With the development o faster and smaller electronics, execution of mass processes at cloud systems have become feasible. Indeed, applications provided by data centers, data warehouses, data workstations have become common features in modern personal and work environments. Communication service(s) provide a wide variety of applications ranging from hosting, management, and/or routine, among others associated with communication(s).

Increasingly, cloud based resources are utilized for variety of services that include communication services, among others that facilitate hosting, management, and/or routing, among other operations associated with assets such as communications. However, there are currently substantial gaps in providing notification(s) based on a dynamic group. Personnel resources are unnecessarily consumed for processing, identifying, searching, and/or assigning notification(s) to communication(s). Lack of relevant management solutions to dynamically provide a notification based on a dynamic group cause poor management of personnel resources and time when attempting to alert a recipient to an incoming communication associated with a member of a dynamic group.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed, to a notification based on a dynamic group. A communication service, according to embodiments, may initiate operations to provide a notification based on a dynamic group upon receiving a communication from a sender that is transmitted to a recipient. Next, the sender may be detected as a member of a dynamic group. Furthermore, a notification may be determined as associated with the dynamic group and a communication type. A client application associated with the recipient may be prompted to render the notification in conjunction with an arrival of the communication.

These and other features and advantages be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating examples of providing a notification based on a dynamic group, according to embodiments;

FIG. 2 is a display diagram illustrating example components of a communication service that provides a notification based on a dynamic group, according to embodiments;

FIG. 3 is a display diagram illustrating components of a scheme to provide a notification based on a dynamic group, according to embodiments;

FIG. 4 is a display diagram illustrating an example of a user experience to provide a notification based on a dynamic group, according to embodiments;

FIG. 5 is a simplified networked environment, where a system according to embodiments may be implemented;

FIG. 6 is a block diagram of an example computing device, which may be used to provide a notification based on a dynamic group; and

FIG. 7 is a logic flow diagram illustrating a process for providing a notification based on a dynamic group, according to embodiments.

### DETAILED DESCRIPTION

As briefly described above, a communication service may provide a notification based on a dynamic group. In an example scenario, the communication service may receive a communication from a sender that is transmitted to a recipient. The communication may include a text based communication, an email, a voice based communication, a visual communication, and/or a video based communication, among others. The communication may also be generated by an online meeting, a desktop sharing session, and/or an application sharing session. The communication service may host, manage, and/or route the communication sent from the sender to the recipient. Next, the sender may be detected as a member of a dynamic group. The dynamic group may include the sender among others who may be inserted into and/or excluded out of the dynamic group based on a membership rule.

A notification may be determined as associated with the dynamic group and a communication type, The notification may include a sound based notification, a text based notification, a visual notification, a video based notification, and/or a physical notification. The communication type may include a text based type, an email based type, a voice based type, a visual based type, and/or video based type, among others. The notification may be assigned to the dynamic group based on a system criteria and/or by the recipient of the communication. Furthermore, a client application associated with the recipient may be prompted to render the notification in conjunction with an arrival of the communication.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network, in a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer'memory, a nan-volatile memory, a hard drive, a flash drive, a floppy disk, or a compact disk, and comparable hardware media.

Throughout this specification, the term “platform” may be a combination of software and hardware components for providing a notification based on a dynamic group. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

A computing device, as used herein, refers to a device comprising at least a memory and a processor that includes a desktop computer, a laptop computer, a tablet computer, a smart phone, a vehicle mount computer, or a wearable computer. A memory may be a removable or non-removable component of a computing device configured to store one or more instructions to be executed by one or more processors. A processor may be a component of a computing device coupled to a memory and configured to execute programs in conjunction with instructions stored by the memory. A file is any form of structured data that is, associated with audio, video, or similar content. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a hard drive, a flash drive, a floppy disk, or a compact disk, and comparable hardware media that includes instructions thereon to automatically save content to a location. A user experience a visual display associated with an application or service through which a user interacts with the application or service. A user action refers to an interaction between a user and a user experience of an application or a user experience provided by a service that includes one of touch input, gesture input, voice command, eye tracking, gyroscopic input, pen input, mouse input, and keyboards input. An application programming interface (API) may be a set of routines, protocols, and tools for an application or service that enable the application or service to interact or communicate with one or more other applications and services managed by separate entities.

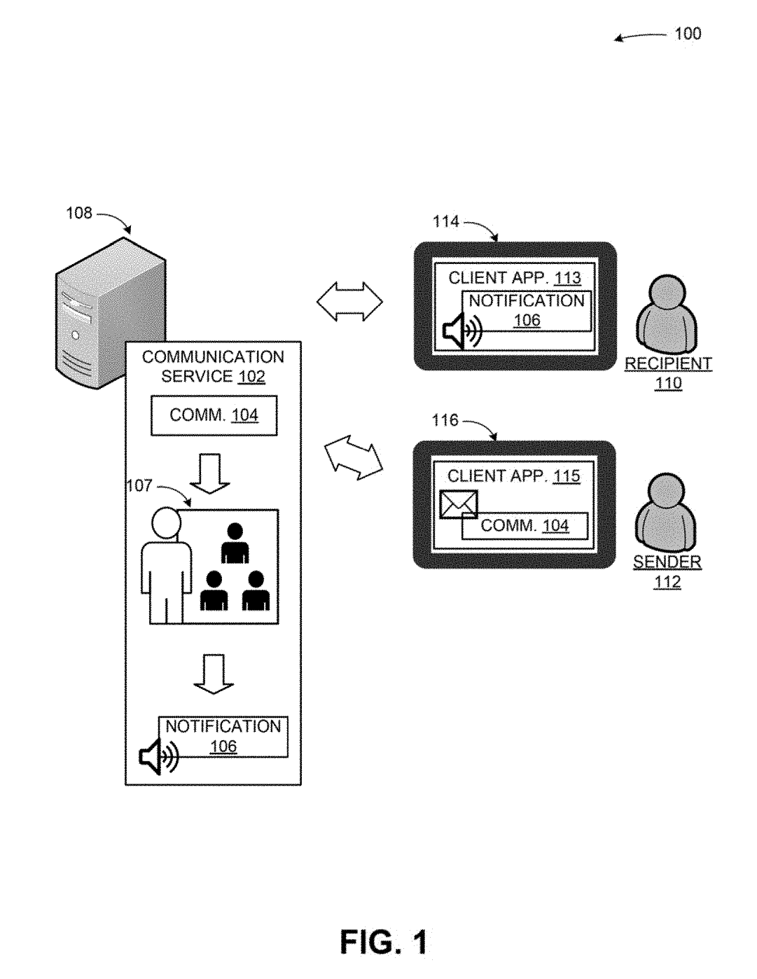

FIG. 1 is a conceptual diagram illustrating examples of providing a notification based on a dynamic group, according to embodiments.

In a diagram 100, a server 108 may execute (or provide) a communication service 102. The server 108 may include a physical server providing service(s), application(s), and/or an interface to client devices. A service (such as the communication service 102) may include an application performing operations in relation to a client application and/or a subscriber, among others. The server 108 may include and/or is part of a workstation, a data warehouse, a data center, and/or a cloud based distributed computing source, among others.

The server 108 may execute the communication service 102 The communication service 102 may receive a communication 104 from a sender 112 that is transmitted to a recipient 110. The sender 112 may generate and/or transmit the communication 104 through a client application 115 (rendered by a client device 116). The communication service may host, manage, and/or route the communication sent from the sender 112 to the recipient 110. The communication 104 may include a text based communication, an email, a voice based communication, a visual communication, and/or a video based communication, among others. The communication 104 may also be generated by an online meeting, a desktop sharing session, and/or an application sharing session. The communication 104 may be formatted based on any customized criteria (such as encryption, among others) associated with the application that generates the communication 104.

The sender 112 may be detected as a member of a dynamic group 107. The dynamic group 107 may include the sender 112 among other entities (such as a person and/or a machine based intelligence) who may be inserted into and/or excluded out of the dynamic group 107 based on a membership rule. The dynamic group 107 may be managed by the communication service 102. Alternatively, the communication service 102 may access a user information provider that manages and/or hosts the dynamic group 107.

A notification 106 may be determined as associated with the dynamic group 107 and a communication type. The notification 106 may include a sound based notification, a text based notification, a visual notification, a video based notification, and/or a physical notification. The physical notification may include moving components of a hardware based scheme that is used to notify the recipient 110. The communication type may include a text based type, an email based type, a voice based type, a visual based type, and/or video based type, among others. The communication service 102 may query properties and/or attributes associated with the dynamic group 107 to find the notification 106 associated with the dynamic group. Furthermore, the notification 106 may be detected as assigned to the dynamic group 107 based on a system criteria and/or by the recipient 110 of the communication 104. Moreover, a client application 113 associated with the recipient 110 may be prompted to render the notification 106 in conjunction with an arrival of the communication 104. For example, a delivery of the notification 106 (associated with the communication 104) may be prioritized over other notification (associated with other communication with a later arrival time compared to an arrival time of the communication 104).

The server 108 may communicate with a client device 114 (providing the client application 113), and/or the client device 116 (providing the client application 115), through a network. The network may provide wired or wireless communications between network nodes such as the client device 114, the client device 116, and/or the server 108, among others. Previous example(s) to provide a notification based on a dynamic group are not provided in a limiting sense. Alternatively, the communication service 102 may determine a notification 106 associated with the dynamic group 107 and prompt the client application 113 to render the notification 104 as a desktop application, a workstation application, and/or a server application, among others. The client application 113 and the client application 115 may also include a client interface interacting with the communication service 102.

The recipient 110 and/or the sender 112 may interact with the client application 113 and/or the client application 115, respectively, with a keyboard based input, a mouse based input, a voice based input, a pen based input, and a gesture based input, among others. The gesture based input may include one or re touch based actions such as a touch action, a swipe action, and a combination of each, among others.

While the example system in FIG. 1 has been described with specific components including the server 108, the communication service 102, embodiments are not limited to these components or system configurations and can be implemented with other system configuration employing fewer or additional components.

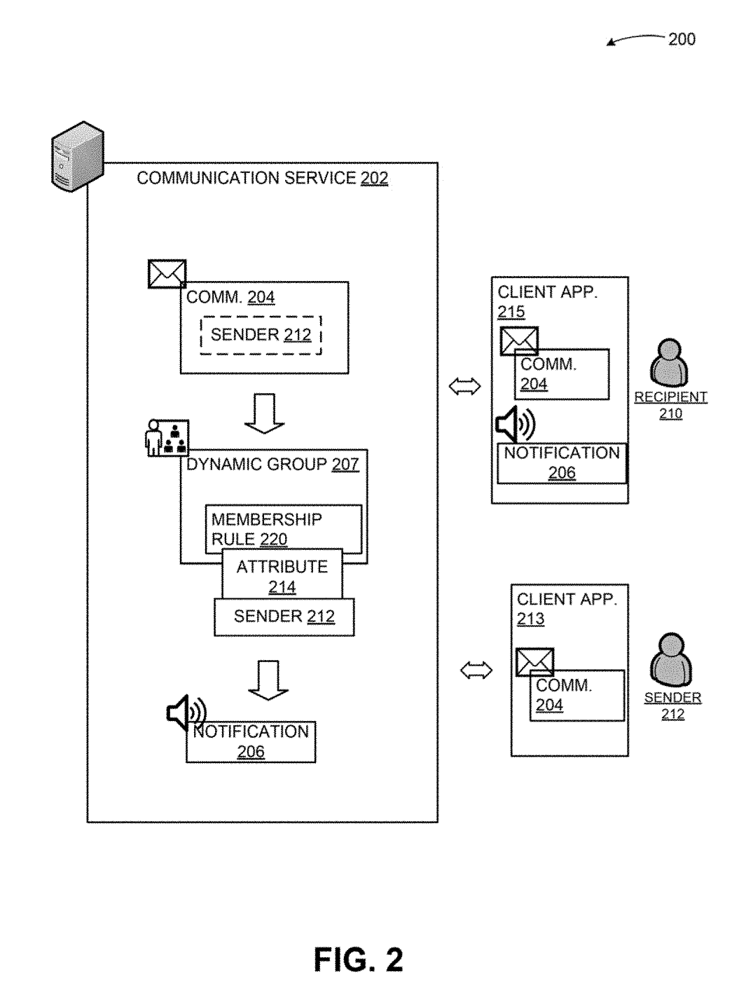

FIG. 2 is a display diagram illustrating example components of a communication service that provides a notification based on a dynamic group, according to embodiments.

As illustrated in diagram 200, a communication service 202 may determine a notification 206 associated with a dynamic group 207. The communication service 202 may prompt a client application 215 to render the notification 206 in communication with an incoming communication such as a communication 204. In an example scenario, a sender 212 may generate and transmit a communication 204 to a recipient 210. The communication 204 may include a text based communication, an email, a voice based communication, a visual communication, and/or a video based communication, among others.

The sender 212 may be detected as a member of the dynamic group 207. Reminding the recipient 210 (that the communication 204 is received from a member of the dynamic group 207) may be crucially important and have a high value to the recipient 210 to allow the recipient 210 to focus priority to the communication 204. Alternatively, organizational rules associated with the recipient 210 may demand that the recipient 210 focus priority to the communication 204 (or others) associated with the dynamic group 207. As such, the communication service 202 may execute operation(s) to alert the recipient 210 that the communication 204 is received from a member of the dynamic group 207.

The communication service 202 may determine a notification as associated with the dynamic group 207 and a communication type of the communication 204. The dynamic group 207 may include the sender 212 and other member(s) who may be added and/or removed from the dynamic group 207 based on a membership rule 220. The membership rule 220 may describe a role in an organization associated with the recipient 210. For example, the member rule may describe a supervisory role of the sender 212 associated with the recipient 210, a co-worker role of the sender 212 associated with the recipient 210, and/or a subordinate role of the sender 212 associated with the recipient 210. The organizational role, as a basis for the dynamic group 207, may hold a level of importance for the recipient 210. The notification 206 rendered with the communication 204 may allow the recipient 210 to respond to the communication 204 based on the level of importance designated to the dynamic group 207.

Furthermore, the membership ride 220 may describe a relationship with the recipient. The dynamic group 207 may encapsulate individual(s) who share a specific relationship with the recipient 210. As such, alerting the recipient 210 to the communication 204 from a member of the dynamic group 207 may allow the recipient 210 to respond to the communication 204 based on an importance and/or other factor(s) associated with the relationship.

Moreover, the membership rule 220 may describe a shared attribute with the recipient 210. The shared attribute may include a variety of attribute(s) and/or property(s) associated with the recipient 210 shared with the sender 212. For example, the shared attribute may include a shared identifier (such as a last name), a shared location, and/or a shared organization (such as a work place), among others. As such, the notification 206 may prompt the recipient 210 to respond to the communication 204 based on a value placed on a member of the dynamic group 207 in accordance with the shared attribute.

Additionally, the communication service 202 may process the membership rule 220 with information associated with the sender 212 to match an attribute 214 to the membership rule 220. The information associated with the sender 212 may be parsed from the communication 204. Alternatively, the client application 213 may be queried for the information associated with the sender 212. If the attribute 214 satisfies the membership rule 220, the sender 212 may be determined to be a member of the dynamic group 207. Alternatively, the communication service 202 may query the dynamic group 207 to detect the sender 212 as a member.

Furthermore, the communication service 202 may determine the notification 206 as assigned to the dynamic group 207 based on information associated with the dynamic group 207. For example, the communication service 202 may search a local data source to query the information associated with the dynamic group 207. Upon detecting the notification 206 as assigned to ale dynamic group 207, the communication service 202 may instruct the client application 215 to render the notification 206 in conjunction with an arrival of the communication 204. Alternatively, the communication service 202 may query a user information provider that manages and/or hosts the dynamic group 207. The communication service 202 may receive the notification 206 as a response (and/or information associated with the notification 206) from the user information provider.

The client application 215 may be prompted to render the notification 206 in conjunction with an arrival of the communication 204 (to alert the recipient 210 of the source of the communication 204 as a member of the dynamic group 207). The notification 206 may be transmitted with the instruction for the client application 215 (to render the notification 206). Alternatively, if the notification 206 is stored locally by the client application 215, the information associated with the notification 206 may be transmitted with the instruction to render the notification 206 (by the client application 215).

In a further example scenario, the communication service 202 may determine a capability of the client application 215 to render and/or display the communication to the recipient 210. If the client application 215 is determined as capable to render the communication 204 then the communication service 202 may further determine a capability of the client application 215 to render the notification 206. If the client application 215 is further determined as capable to render the notification 206 then the client application 215 may be prompted to render the notification 206 in conjunction with the arrival of the communication 204.

Alternatively, the client application 215 may be determined as incapable of rendering the notification 206 (such as a sound based notification, a video based notification, a visual notification which may include an animation, a highlighting pattern, and/or a lighting pattern, among others). In such a scenario, the communication service 202 may attempt to locate an alternative client, application associated with the recipient 210 that may be capable of rendering the communication 204 as well as the notification 206. Upon locating the alternative client application, the communication service 202 may prompt the alternative client application to render the communication 204 and the notification 206 in conjunction with the arrival of the communication 204.

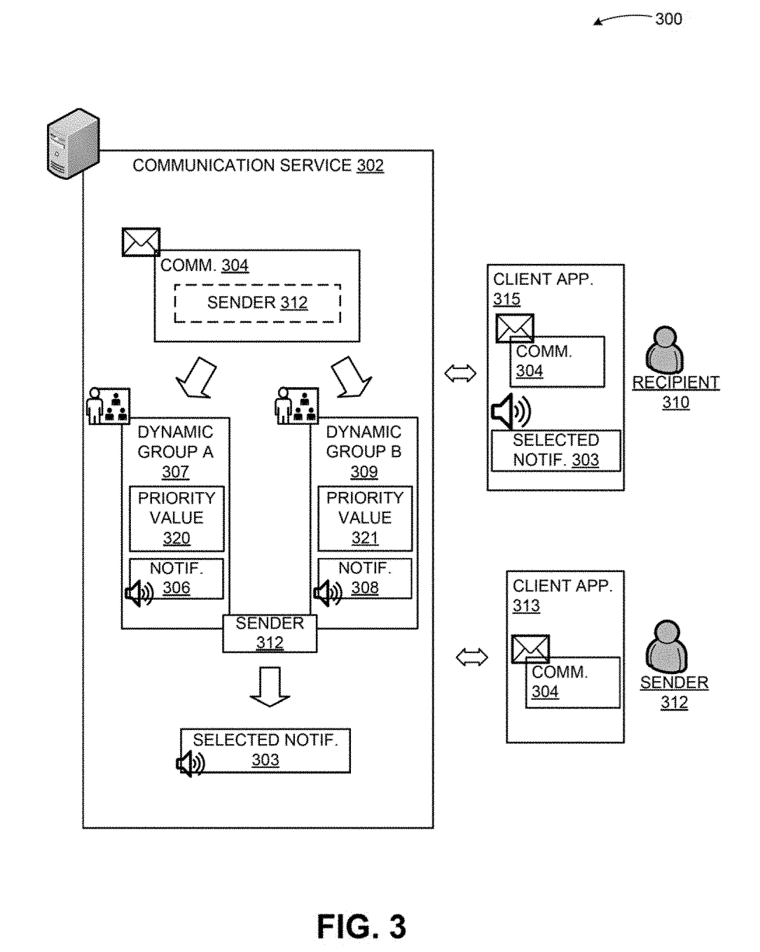

FIG. 3 is a display diagram illustrating components of a scheme to provide a notification based on a dynamic group, according to embodiments.

As shown in a diagram 300, a communication service 302 may detect a sender 312 of a communication 304 as a member of a dynamic group A 307 and a dynamic group B 309. In such a scenario, the communication service 302 may execute operation(s) to determine a value associated with each of the groups in relation to the recipient 310.

For example, the communication service 302 may determine a priority value 320 associated with the dynamic group A 307. A priority value 321 may also be determined for the dynamic group 309. The priority value 320 and the priority value 321 may be assigned by the recipient 310 and/or by a machine learning scheme assigning values to each of the dynamic groups A and B (307 and 309) based on properties associated with the groups. For example, the dynamic group A 307 encompassing supervisor(s) of the recipient 310 may be ranked with a higher value compared to the dynamic group B 309 encompassing subordinate(s) of the recipient 310. Values associated with property(s) and/or attribute(s) of, the groups may be aggregated to result in the priority values assigned to the groups.

In an example scenario, if the priority value 320 assigned to the dynamic group A 307 is determined as higher than or equal to the priority value 321 assigned to the dynamic group B 309 then a notification 306 associated with the dynamic group A 309 may be selected for rendering by client application 315 (in conjunction with an arrival of the communication 304). Alternatively, if the priority value 320 assigned to the dynamic group A 307 is determined as less than the priority value 321 assigned to the dynamic group B 309 then a notification 308 associated with the dynamic group B 309 may be selected for rendering by the client application 315.

The communication service 302 may select the notification 30 or the notification 308 as a selected notification 303 based on a priority value associated each of the assigned dynamic groups. The client application 315 may be instructed to render the selected notification 303 in conjunction with an arrival of the communication 304.

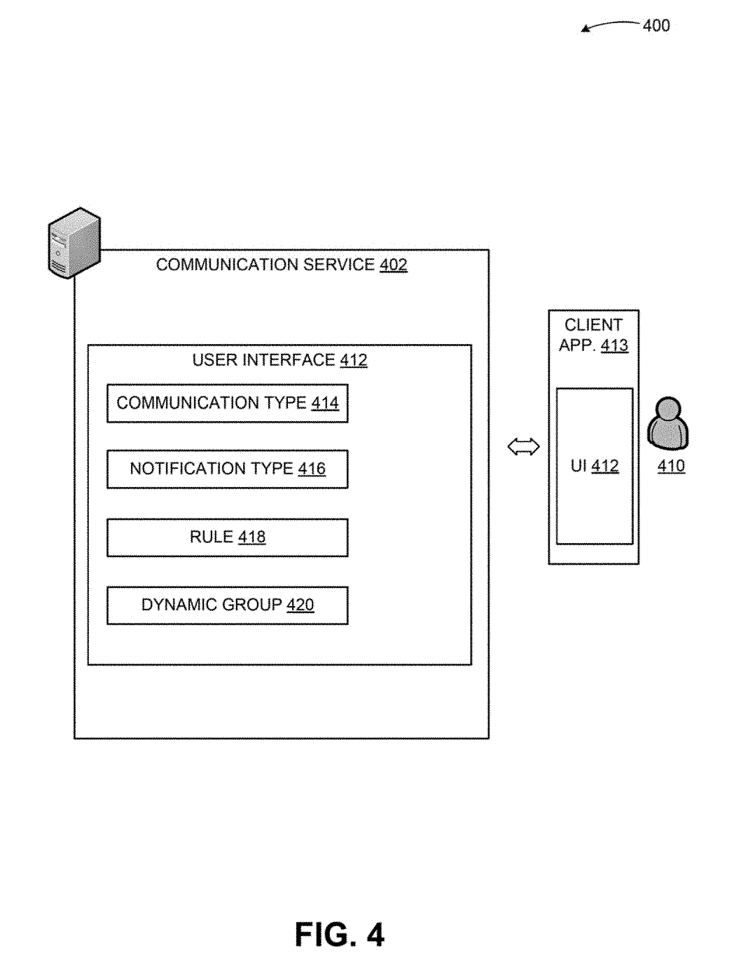

FIG. 4 is a display diagram illustrating an example of a user experience to provide a notification based on a dynamic group, according to embodiments.

As shown in a diagram 400, a communication service 402 may generate a user interface 412 for configuring bow the communication service 402 provides a notification associated with a dynamic group to the recipient 410 (or other authorized user). The communication service 402 may provide the user interface 412 to a client application 413 for rendering to the recipient 410. The recipient 410 may interact with the user interface 412 through the client application 413.

The recipient 410 may be provided with an option to configure the dynamic group 420. Through the option, the recipient 410 may be enabled to provide information to configure the dynamic group 420. The recipient 410 may also be provided with an option to configured a rule 418. The recipient 410 may be allowed to configure the rule 418 determine whether the sender is a member of the dynamic group 420 based on an attribute and/or a property of the sender.

The user interface 412 may also include options for configuring a communication type 414 and a notification type 416. The option for the communication type 414 may be used to provide further granularity for selecting a notification for the dynamic group 420. For example, the recipient 410 may be provided with the option to select an initial notification for a text based communication type and a secondary notification for a video based communication type from a member of the dynamic group 420. The option for the notification type 416 may be used to input and configure the notification for the dynamic group 420. For example, a notification sound may be selected through the option for the notification type 416 for the dynamic group 420.

As discussed above, the communication service may be employed to perform operations to provide a notification based on a dynamic group. An increased performance and efficiency improvement with the communication service 102 may occur as a result of automatically determining a notification for a dynamic group. Additionally, automated group membership determination of a sender and notification determination associated with a dynamic group based operation(s) and process(es) executed by the communication service 102, may reduce processor load, increase processing speed, conserve memory, and reduce network bandwidth usage.

Embodiments, as described herein, address a need that arises from a lack of efficiency to provide a notification based on a dynamic group. The actions/operations described herein are not a mere use of a computer, but address results that are a direct consequence of software used as a service offered to large numbers of users and applications.

The example scenarios and schemas in FIG. 1 through 4 are shown with specific components, data types, and configurations. Embodiments are not limited to systems according to these example configurations. Providing a notification based on a dynamic group may be implemented in configurations employing fewer or additional components in applications and user interfaces. Furthermore, the example schema and components shown in FIG. 1 through 4 and their subcomponents may be implemented in a similar manner with other values using the principles described herein.

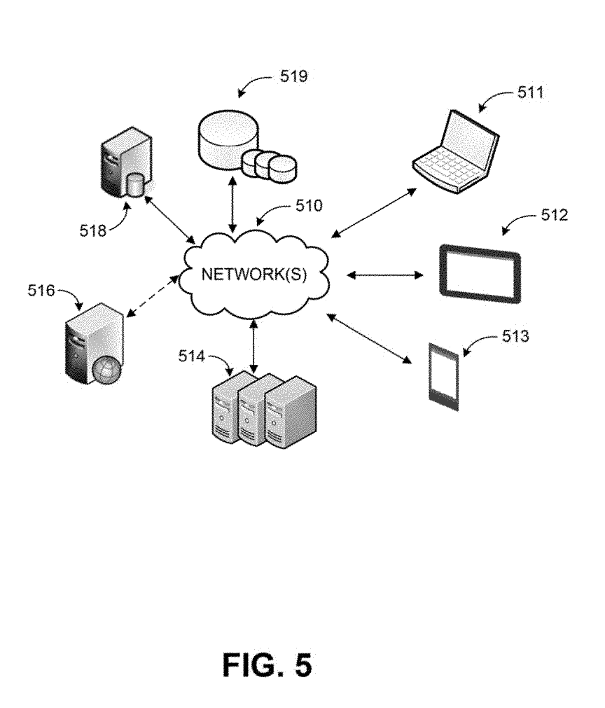

FIG. 5 is an example networked environment, where embodiments may be implemented. A communication service configured to provide a notification based on a dynamic group may be implemented via software executed over one or more servers 514 such as a hosted service. The platform may communicate with client applications on individual computing devices such as a smart phone 513, a mobile computer 512, or desktop computer 511 (‘client devices’) through network(s) 510.

Client applications executed on any of the client devices 511-513 may facilitate communications via application(s) executed by servers 514, or on individual server 516. A communication service may receive a communication from a sender that is transmitted to a recipient. Next, the sender may be detected as a member of a dynamic group. Furthermore, a notification may be determined as associated with the dynamic group and a communication type. A client application associated with the recipient may be prompted to render the notification in conjunction with an arrival of the communication. The communication service may store data associated with the dynamic group in data store(s) 519 directly or through database server 518.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include, short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to provide a notification based on a dynamic group. Furthermore, the networked environments discussed in FIG. 5 are for illustration purposes only. Embodiments are not limited to the example applications, modules, or processes.

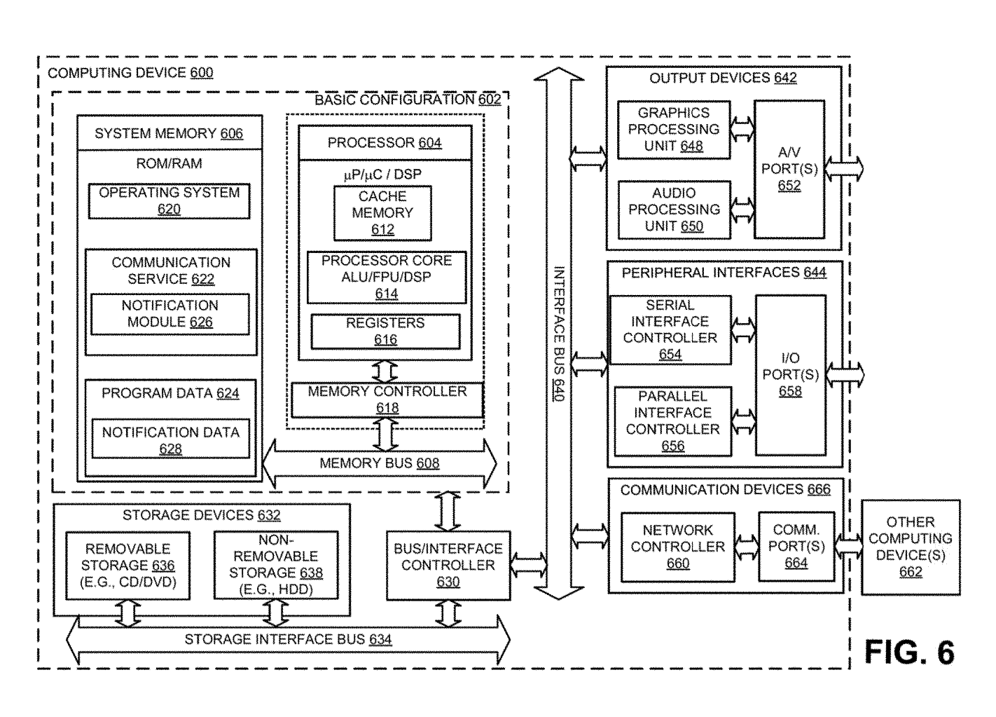

FIG. 6 is a block diagram of an example computing device, which may be used to provide a notification based on a dynamic group, according to embodiments.

For example, computing device 600 may be used as a server, desktop computer, portable computer, smart phone, special purpose computer, or similar device. In an example basic configuration 602, the computing device 600 may include one or more processors 604 and a system memory 606. A memory bus 608 may be used for communication between the processor 604 and the system memory 606. The basic configuration 602 may be illustrated in FIG. 6 by those components within the inner dashed line.

Depending on the desired configuration, the processor 604 may be of any type, including but not limited to a microprocessor (μP), a microcontroller (μC), a digital signal processor (DSP), or any combination thereof. The processor 604 may include one more levels of caching, such as a level cache memory 612, one or more processor cores 614, and registers 616. The example processor cores 614 may (each) include an arithmetic logic unit (ALU), a floating point unit (FPU), a digital signal processing core (DSP Core), a graphics processing unit (GPU), or any combination thereof. An example memory controller 618 may also be used with the processor 604, or in some implementations, the memory controller 618 may be an internal part of the processor 604.

Depending on the desired configuration, the system memory 606 may be of any type including but not limited to volatile memory (such as RAM), non-volatile memory (such as ROM, flash memory, etc.), or any combination thereof. The system memory 606 may include an operating system 620, a communication service 622, and a program data 624. The communication service 622 may include components such as a notification module 626. The notification module 626 may execute the processes associated with the communication service 622. The notification module 626 may receive a communication from a sender that is transmitted to a recipient. Next, the sender may be detected as a member of a dynamic group. Furthermore, a notification may be determined as associated with the dynamic group and a communication type. A client application associated with the recipient may be prompted to render the notification in conjunction with an arrival of the communication.

Input to and output out of the communication service 622 may be transmitted through a communication device 666 that may be communicatively coupled to the computing device 600. The communication device 666 may provide wired and/or wireless communication. The program data 624 may also include, among other data, notification data 628, or the like, as described herein. The notification data 628 may include information associated with a dynamic group, a communication, a sender, and/or a recipient, among others.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more, non-removable storage devices 638, or, a combination thereof. Examples of the removable storage and the non-removable storage devices may include magnetic disk devices, such as flexible disk drives and hard-disk drives (HDDs), optical disk drives such as compact disk (CD) drives or digital versatile disk (DVD) drives, solid state drives (SSDs), and tape drives, to name a few. Example computer storage media may include volatile and nonvolatile, removable, and non-removable media implemented in any method or technology for storage of information, such as computer-readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (for example, one or more output devices 642, one or more peripheral interfaces 644, and one or more communication devices 666) to the basic configuration 602 via the bus/interface controller 630. Some of the example output devices 642 include a graphics processing twit 648 and an audio processing unit 650, which may be configured to communicate to various external devices such as a display or speakers via one or more A/V ports 652. One or more example peripheral interfaces 644 may include a serial interface controller 654 or a parallel interface controller 656, which may be configured to communicate with external devices such as input devices (for example, keyboard, mouse, pen, voice input device, touch input device, etc.) or other peripheral devices (for example, printer, scanner, etc.) via one or more I/O ports 658. An example of the communication device(s) 666 includes a network controller 660, which may be arranged to facilitate communications with one or more other computing devices 662 over a network communication link via one or more communication ports 664. The one or more other computing devices 662 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information deliver media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a part of a specialized server, mainframe, or similar computer, which includes any of the above functions. The computing device 600 may also be implemented as a personal computer including both laptop computer and non-laptop computer configurations. Additionally, the computing device 600 may include specialized hardware such as an application-specific integrated circuit (ASIC), a field programmable gate array (FPGA), a programmable logic device (PLD), and/or a free form logic on an integrated circuit (IC), among others.

Example embodiments may also include methods to provide a notification based on a dynamic group. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

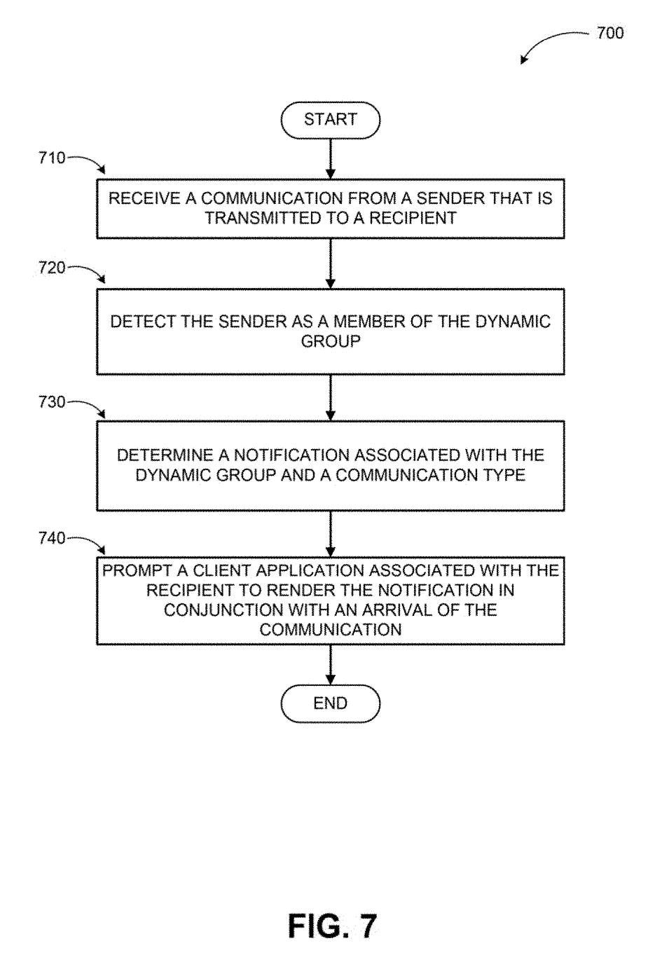

FIG. 7 is a logic flow diagram illustrating a process for providing a notification based on a dynamic group, according to embodiments. Process 700 may be implemented on a computing device, such as the computing device 600 or another system.

Process 700 begins with operation 710, where a communication service may receive a communication from a sender that is transmitted to a recipient. The communication may include a text based communication, an email, a voice based communication, a visual communication, and/or a video based communication, among others. Next, at operation 720, the sender may be detected as a member of a dynamic group. The dynamic group may include the sender among others who may be inserted into and/or excluded out of the dynamic group based on a membership rule.

At operation 730, a notification may be determined as associated with the dynamic group and a communication type. The notification may include a sound based notification, a text based notification, a visual notification, a video based notification, and/or a physical notification. The communication type may include a text based type, an email based type, a voice based type, a visual based type, and/or video based type, among others. At operation 740, a client application associated with the recipient may be prompted to render the notification in conjunction with an aid vat of the communication.

The operations included in process 700 is for illustration purposes. Providing a notification based on a dynamic group may be implemented by similar processes with fewer or additional steps, as well as in different order of operations using the principles described herein. The operations described herein may be executed by one or more processors operated on one or more computing devices, one or more processor cores, specialized processing devices, and/or special purpose processors, among other examples.

According to some examples, a method to provide a notification based on a dynamic group is described. The method includes receiving a communication from a sender that is transmitted to a recipient, detecting the sender as a member of the dynamic group, determining the notification as associated with the dynamic group and a communication type, and prompting a client application associated with the recipient to render the notification in conjunction with an arrival of the communication.

According to other examples, the notification includes one or more of a sound based notification, a text based notification, a visual notification, a video based notification, and a physical notification. Detecting the sender as the member of the dynamic group includes identifying a membership rule associated the dynamic group and detecting an attribute associated with the sender that fulfills the membership rule. The membership rule describes a role in an organization associated with the recipient. The membership rule describes a relationship with the recipient. The membership rule describes a shared attribute with the recipient.

According to further examples, the method further includes upon confirming a first capability of the client application to render the communication, validating a second capability of the client application to render the notification. The method further includes receiving a second communication from a second sender that is transmitted to the recipient, detecting the second sender as excluded from the dynamic group, and instructing the client application to render a default notification associated with a type of the second communication.

According to other examples, the method further includes detecting the sender as a member of a second dynamic group; and selecting one of the notification associated with the dynamic group and other notification associated with the second dynamic group for rendering by the client application based on context of the communication, a rule associated with the communication, and the communication type. The method further includes receiving a configuration input from the recipient, where the configuration input includes an operation to assign a custom notification to the dynamic group and assigning the custom notification to the dynamic group. The communication type includes one or more of a text based communication, an email, a voice based communication, a visual communication, and a video based communication.

According to some examples, a server configured to provide a notification based on a dynamic group is described. The server includes as communication device configured to facilitate communication between a communication service and one or more client devices, a memory configured to store instructions, and a processor coupled to the memory and the communication device. The processor executes the communication service in conjunction with the instructions stored in the memory. The communication service includes a notification module. The notification module is configured to receive, through the communication device, an email from a sender that is transmitted to a recipient, detect the sender as a member of an initial dynamic group, determine an initial notification sound as associated with the initial dynamic group and a communication type, and prompt, through the communication device, a client application associated with the recipient to render the notification sound in conjunction with an arrival of the communication.

According to other examples, the notification module is further configured to receive, through the communication device, second email from a second sender that is transmitted to the recipient, detect the second sender as a member of a second dynamic group, and determine a visual notification associated with the second dynamic group. The notification module is further configured to detect a capability to render the visual notification by the client application and prompt, through the communication device, the client application to render the visual notification. The notification module is further configured to detect an inability to render the visual notification by the client application, determine an alternate client application associated with the recipient, where the alternate client application includes a capability to render the visual notification, and prompt, through the communication device, the alternate client application to render the visual notification.

According to further examples, the notification module is further configured to receive a new email from the sender that is transmitted to the recipient, detect the sender as a member of a second dynamic group, determine a second notification sound associated with the second dynamic group, and determine a first priority value associated with the initial dynamic group and a second priority value associated with the second dynamic group. The notification module is further configured to determine the first priority value as higher than or equal to the second priority value and prompt, through the communication device, the client application to render the initial notification sound. The notification module is further configured to determine the second priority value as lower than the second priority value and prompt, through the communication device, the client application to render the second notification sound.

According to some examples, a method to provide a notification based on a dynamic group is described. The method includes presenting a user interface to identify a group or a specific person, presenting an option on the user interface to identify a communication type, presenting another option on the user interface to identify a notification type, constructing a rule to provide the notification upon an arrival of a communication from a sender based on the identified group, the communication type, and the notification type, and providing the notification upon the arrival of the communication based on the constructed rule.

According to other examples, the communication is generated by one or more of an online meeting, a desktop sharing session, and an application sharing session.

According to some examples a means for providing a notification based on a dynamic group is described. The means for providing a notification based on a dynamic group includes a means for receiving a communication from a sender that is transmitted to a recipient, a means for detecting the sender as a member of the dynamic group, a means for determining the notification as associated with the dynamic group and a communication type, and a means for prompting a client application associated with the recipient to render the notification in conjunction with an arrival of the communication.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to provide a notification based on a dynamic group, the method comprising:
receiving a communication from a sender that is transmitted to a recipient;
detecting the sender as a member of the dynamic group;
determining the notification as associated with the dynamic group and a communication type; and
prompting a client application associated with the recipient to render the notification in conjunction with an arrival of the communication.

2. The method of claim 1, wherein the notification includes one or more of a sound based notification, a text based notification, a visual notification, a video based notification, and a physical notification.

3. The method of claim 1, wherein detecting the sender as the member of the dynamic group comprises:
identifying a membership rule associated the dynamic group; and
detecting an attribute associated with the sender that fulfills the membership rule.

4. The method of claim 3, wherein the membership rule describes a role in an organization associated with the recipient.

5. The method of claim 3, wherein the membership rule describes a relationship with the recipient.

6. The method of claim 3, wherein the membership rule describes a shared attribute with the recipient.

7. The method of claim 1, further comprising:
upon confirming a first capability of the client application render the communication, validating a second capability of the client application to render the notification.

8. The method of claim 1, further comprising:
receiving a second communication from a second sender that is transmitted to the recipient;
detecting the second sender as excluded from the dynamic group; and
instructing the client application to render a default notification associated with a type of the second communication.

9. The method of claim 1, further comprising:
detecting the sender as a member of a second dynamic group; and
selecting one of the notification associated with the dynamic group and other notification associated with the second dynamic group for rendering by the client application based on a context of the communication, a rule associated with the communication, and the communication type.

10. The method of claim 1, further comprising:
receiving a configuration input from the recipient, wherein the configuration input includes an operation to assign a custom notification to the dynamic group; and
assigning the custom notification to the dynamic group.

11. The method of claim 1, wherein the communication type includes one or more of a text based communication, an email, a voice based communication, a visual communication, and a video based communication.

12. A server configured to provide a notification based on a dynamic group, the server comprising:
a communication device configured to facilitate communication between a communication service and one or more client devices;
a memory configured to store instructions; and
a processor coupled to the memory and the communication device, the processor executing the communication service in conjunction with the instructions stored in the memory, wherein the communication service includes:
a notification module configured to:
receive, through the communication device, an email from a sender that is transmitted to a recipient;
detect the sender as a member of an initial dynamic group;
determine an initial notification sound as associated with the initial dynamic group and a communication type; and
prompt, through the communication device, a client application associated with the recipient to render the initial notification sound in conjunction with an arrival of the communication,

13. The server of claim 12, wherein the notification module is further configured to:
receive, through the communication device, a second email from a second sender that is transmitted to the recipient;
detect the second sender as a member of a second dynamic group; and
determine a visual notification associated with the second dynamic group.

14. The server of claim 13, wherein the notification module is further configured to:
detect a capability to render the visual notification by the client application; and
prompt, through the communication device, the client application to render the visual notification.

15. The server of claim 13, wherein the notification module is further configured to:
detect an inability to render the visual notification by the client application;
determine an alternate client application associated with the recipient, wherein the alternate client application includes a capability to render the visual notification; and
prompt, through the communication device, the alternate client application to render the visual notification.

16. The server of claim 12, wherein the notification module is further configured to:
receive a new email from the sender that is transmitted to the recipient;
detect the sender as a member of a second dynamic group;
determine a second notification sound associated with the second dynamic group; and
determine a first priority value associated with the initial dynamic group and a second priority value associated with the second dynamic group.

17. The server of claim 16, wherein the notification module is further Configured to:
determine the first priority value as higher than or equal to the second priority value; and
prompt, through the communication device, the client application to render the initial notification sound.

18. The server of claim 16, wherein the notification module is further configured to:
determine the second priority value as lower than the second priority value; and
prompt, through the communication device, the client application to render the second notification sound.

19. A method to provide a notification based on a dynamic group, the method comprising:
presenting a user interface to identify a group or a specific person;
presenting an option on the user interface to identify a communication type;
presenting another option on the user interface to identify a notification type;
constructing a rule to provide the notification upon an arrival of a communication from a sender based on the identified group, the conga communication type, and the notification type; and
providing the notification upon the arrival of the communication based on the constructed rule.

20. The method of claim 19, wherein the communication is generated by one or more of in online meeting, a desktop sharing session, and an application sharing session.
